(19) United States
(12) Patent Application Publication
(10) Pub. No.: US 2023/0023723 A1
(43) Pub. Date: Jan. 26, 2023

(54) TRANSPARENT SECURITY AND POLICY ENFORCEMENT FOR LOW-CODE ORCHESTRATION

(71) Applicant: Cisco Technology, Inc., San Jose, CA (US)

(72) Inventors: Pascale Delaunay, La Verne, CA (US); Derek ENGI, Ferndale, MI (US); Gonzalo SALGUEIRO, Raleigh, NC (US); Julie ALLEN, Sioux Falls, SD (US)

(21) Appl. No.: 17/385,444

(22) Filed: Jul. 26, 2021

(51) Int. Cl. H04L 29/06; G06F 21/62

(52) U.S. Cl. CPC H04L 63/205; G06F 21/62; H04L 63/1425; G06F 21/6245

(57) ABSTRACT

In one embodiment, a device inserts a watcher module between a first module and a second module in a low-code workflow. The device intercepts, via the watcher module, output data being passed by the first module to the second module. The device determines whether the output data represents a policy violation. The device blocks, via the watcher module, the output data from being input to the second module, when the output data represents a policy violation.

### TECHNICAL FIELD

The present disclosure relates generally to computer networks, and, more particularly, to transparent security and policy enforcement for low-code orchestration.

### BACKGROUND

The creation of models, ontologies, diagrams, software programs, and other similar artifacts remains a very time consuming and resource intensive activity. Recently, efforts have focused on simplifying programming environments by representing portions of code in a visual manner. In doing so, programmers no long need to write many lines of code to create a program, but simply need to manipulate a graphical user interface (GUI) to do so. Indeed, the promise of drag-and-drop functionality in a programming environment greatly simplifies the programming process in a manner that would allow non-technical users build software applications. However, this also comes at a greater risk of a user creating a program that presents a security risk, exposes private or other sensitive data, or the like.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example computer network;

FIG. 2 illustrates an example network device/node;

FIG. 3 illustrates an example of the execution of a low-code workflow;

FIG. 4 illustrates an example architecture for using a watcher module in a low-code workflow;

FIG. 5 illustrates an example of a watcher module blocking use of data in a low-code workflow; and

FIG. 6 illustrates an example simplified procedure for evaluating data passed in a low-code workflow.

### DESCRIPTION OF EXAMPLE EMBODIMENTS

### Overview

According to one or more embodiments of the disclosure, a device inserts a watcher module between a first module and a second module in a low-code workflow. The device intercepts, via the watcher module, output data being passed by the first module to the second module. The device determines whether the output data represents a policy violation. The device blocks, via the watcher module, the output data from being input to the second module, when the output data represents a policy violation.

### Description

A computer network is a geographically distributed collection of nodes interconnected by communication links and segments for transporting data between end nodes, such as personal computers, cellular phones, workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to forward data from one network to another.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

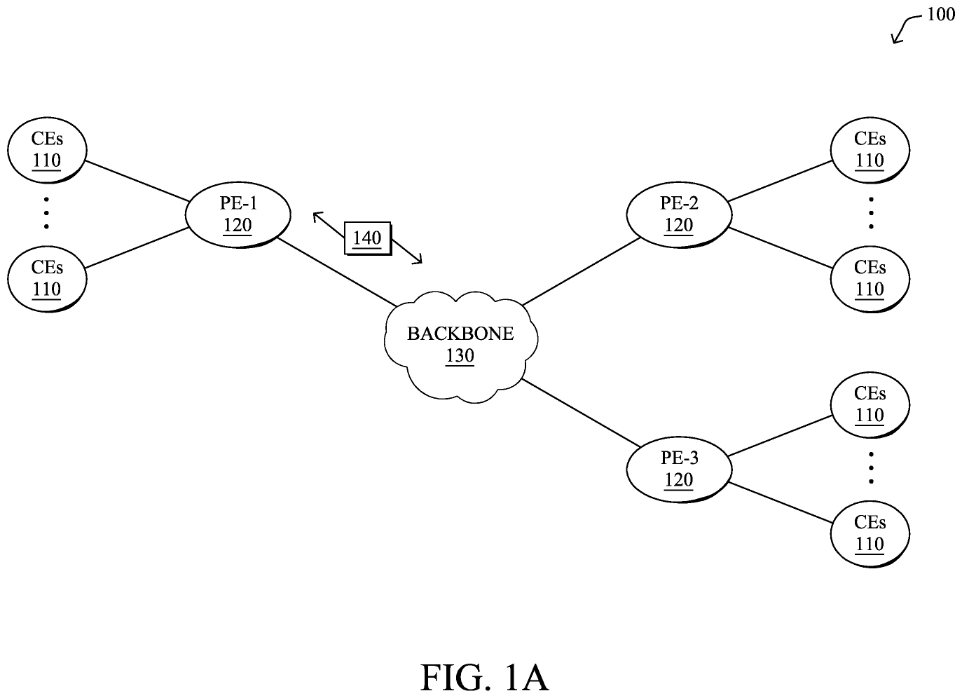

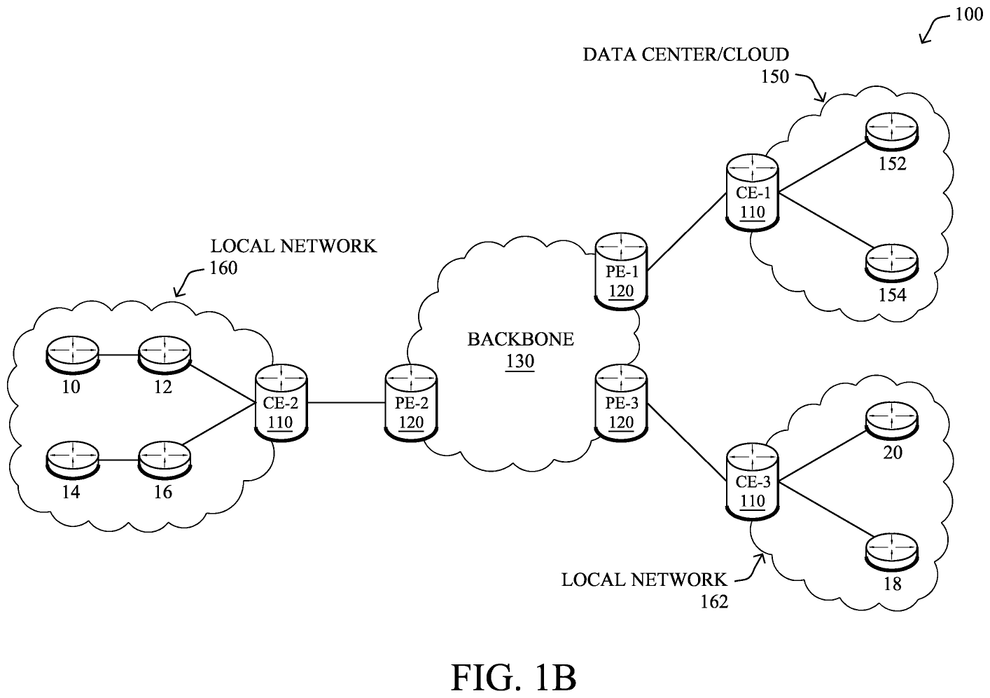

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN utilizing a Service Provider network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different Service Providers) using a single CE router, with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include nodes/devices 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often deployed on what are referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

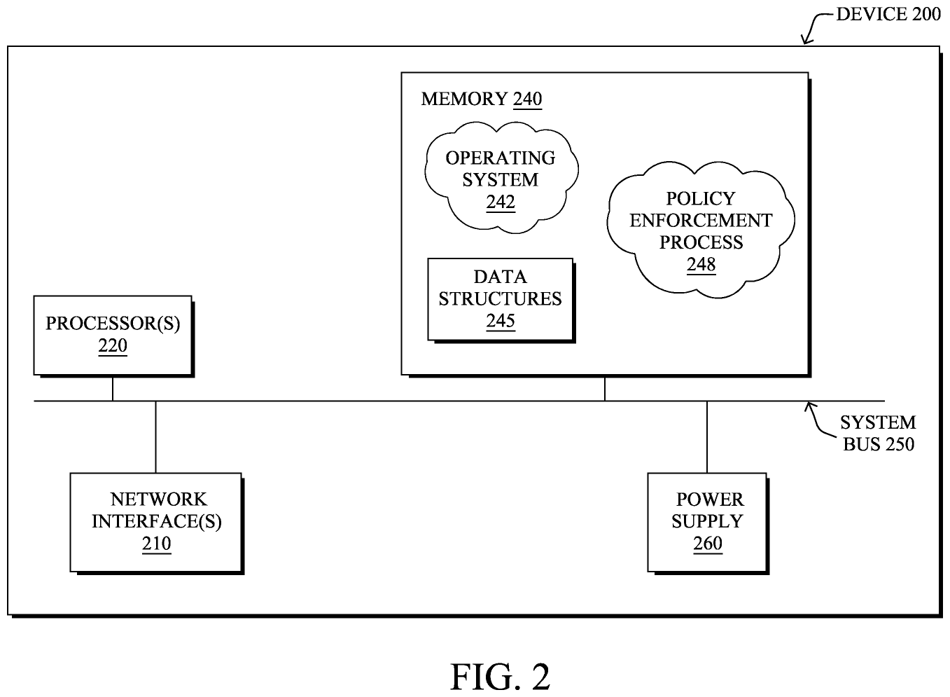

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/devices 10-20, servers 152-154 (e.g., a network controller located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a policy enforcement process 248 for a low-code development environment, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

Policy enforcement process 248 includes computer executable instructions that, when executed by processor(s) 220, cause device 200 to enforce policies with respect to a low-code environment. In various embodiments, policy enforcement process 248 may utilize machine learning techniques, in whole or in part, to perform its analysis and reasoning functions. In general, machine learning is concerned with the design and the development of techniques that take as input empirical data (such as network statistics and performance indicators) and recognize complex patterns in these data. One very common pattern among machine learning techniques is the use of an underlying model M, whose hyper-parameters are optimized for minimizing the cost function associated to M, given the input data. The learning process then operates by adjusting the hyper-parameters such that the number of misclassified points is minimal. After this optimization phase (or learning phase), the model M can be used very easily to classify new data points. Often, M is a statistical model, and the minimization of the cost function is equivalent to the maximization of the likelihood function, given the input data.

In various embodiments, policy enforcement process 248 may employ one or more supervised, unsupervised, or self-supervised machine learning models. Generally, supervised learning entails the use of a training large set of data, as noted above, that is used to train the model to apply labels to the input data. For example, in the case of policy violations, the training data may include examples that have been labeled as violations or not violations, accordingly. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Self-supervised is a representation learning approach that eliminates the pre-requisite requiring humans to label data. Self-supervised learning systems extract and use the naturally available relevant context and embedded metadata as supervisory signals. Self-supervised learning models take a middle ground approach: it is different from unsupervised learning as systems do not learn the inherent structure of data, and it is different from supervised learning as systems learn entirely without using explicitly-provided labels.

Example machine learning techniques that policy enforcement process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) artificial neural networks (ANNs) (e.g., for non-linear models), replicating reservoir networks (e.g., for non-linear models, typically for time series), random forest classification, or the like. Accordingly, policy enforcement process 248 may employ deep learning, in some embodiments. Generally, deep learning is a subset of machine learning that employs ANNs with multiple layers, with a given layer extracting features or transforming the outputs of the prior layer.

As noted above, recent efforts have focused on simplifying programming environments by representing portions of code in a visual manner. In doing so, programmers no long need to write many lines of code to create a program, but simply need to manipulate a graphical user interface (GUI) to do so. Such programming environments are often referred to as “low-code” development platforms, which incorporate at least some GUI-based functionality in lieu of traditional hand-coded programing. A subset of low-code systems includes “no-code” platforms which are fully graphical in nature. For purposes of the teachings herein, the term “low-code” is intended to be inclusive of “no-code” approaches.

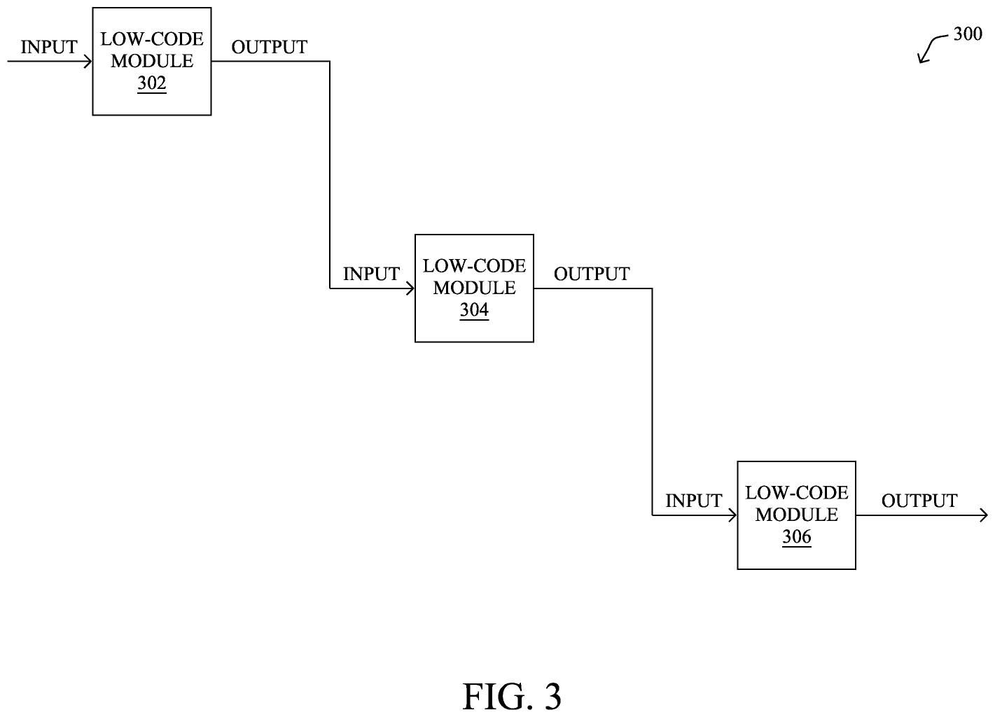

By way of example, FIG. 3 illustrates an example of the execution of a low-code workflow, according to various embodiments. As shown, low-code workflow 300 may include a plurality of modules, such as low-code module 302, low-code module 304, and low-code module 306. Each of these modules 302-306 may comprise different portions of code and may, in various cases, be presented to a user in a graphical manner (e.g., via a drag-and-drop mechanism, etc.). While only three modules 302-306 are shown for purposes of simplicity, an application may include any number of low-code modules, as desired.

As would be appreciated, each of low-code modules 302-306 may input certain data and output certain data, depending on their configurations. Thus, workflow 300 may be created by linking the output of any given module to the input of another given module. For instance, low-code module 304 may take as input the output data from low-code module 302, low-code module 306 may take as input the output data of low-code module 304, etc. This results in a processing workflow between the different modules, as part of the final application.

A key observation is that visibility into the data being passed between modules tends to become lost, as modules are added to a low-code workflow. In addition, there are typically no vulnerability assessments or compliance checks performed against an added module or against the data being accessed by that module. Being able to evaluate the projected use of output data from one module into other modules provides the ability to monitor the concept of data flow throughout the module chain, and evaluate data protection and security concerns along the way.

### Transparent Security and Policy Enforcement for Low-Code Orchestration

The techniques herein promote secure coding practices and corporate policy enforcement by decoupling the low-code widget block from existing workflows and adding intelligence for better policy and compliance evaluations, allowing new developers to securely innovate without compromising security. In some aspects, the techniques herein introduce a ‘watcher module’ that allows for the integration of intelligence into a low-code workflow, to proactively “look ahead” and create “Transaction Profiles” from continuous behavior analysis. This allows the system to fortify the low-code process by addressing the user as a vulnerability in addition to auditing the code and modules.

Illustratively, the techniques described herein may be performed by hardware, software, and/or firmware, such as in accordance with the policy enforcement process 248, which may include computer executable instructions executed by the processor 220 (or independent processor of interfaces 210), to perform functions relating to the techniques described herein.

Specifically, according to various embodiments, a device inserts a watcher module between a first module and a second module in a low-code workflow. The device intercepts, via the watcher module, output data being passed by the first module to the second module. The device determines whether the output data represents a policy violation. The device blocks, via the watcher module, the output data from being input to the second module, when the output data represents a policy violation.

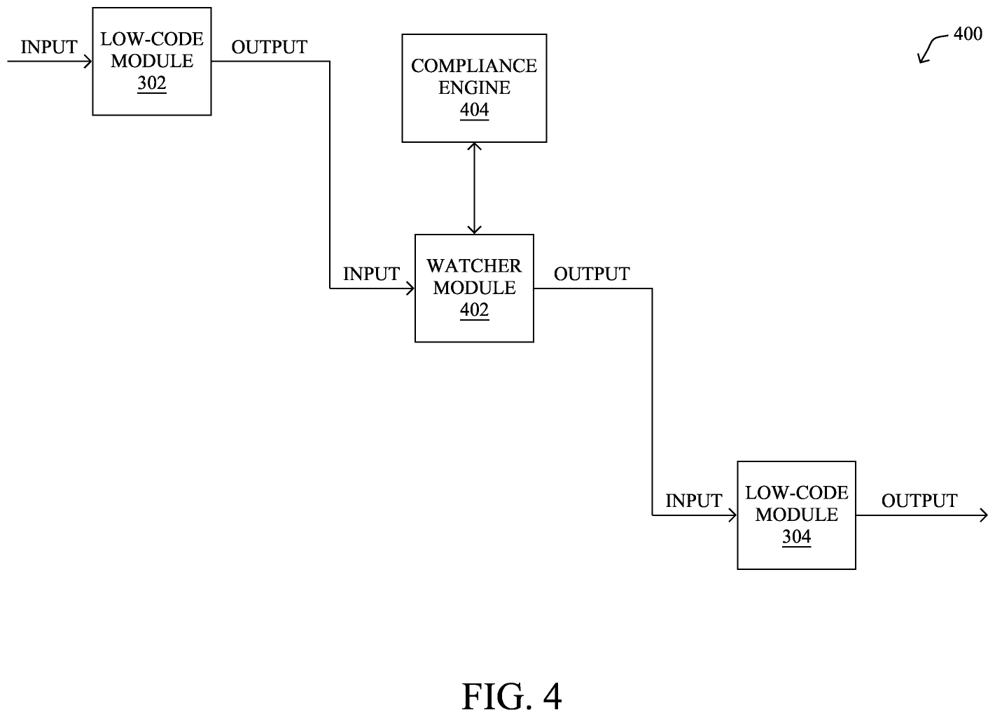

Operationally, FIG. 4 illustrates an example architecture 400 for using a watcher module in a low-code workflow. According to various embodiments, the techniques herein propose the insertion of a ‘watcher’ module into the low-code process, to act as a compliance agent to extract and verify security compliance. This integrates well with existing corporate security infrastructure systems to ensure low-code processes and workflows are as secure as traditional development in the enterprise.

In various embodiments, a watcher module 402 may be inserted into the low-code workflow between low-code modules. For instance, watcher module 402 may be inserted between low-code module 302 and low-code module 304. During execution, watcher module 402 may take as input the output data from low-code module 302, prior to any use of that data as input by low-code module 304. In turn, watcher module 402 may provide the extracted output data from low-code module 302 to a compliance engine 404, which determines whether the output data violates a defined policy.

In various embodiments, watcher module 402 may be a generic low-code module configured to take any form of data as input for analysis by compliance engine 404. In other embodiments, watcher module 402 may be generated by the executing device, based on low-code module 302 and/or low-code module 304, such as the schemas of their respective outputs and inputs. In addition, while compliance engine 404 is shown separately from that of watcher module 402, further embodiments provide for these components to perform their operations as a single component. In other words, while architecture 400 depicts watcher module 402 sending the output data of low-code module 302 to compliance engine 404 for analysis, other embodiments provide for watcher module 402 itself to perform this analysis.

If compliance engine 404 determines that the output of low-code module 302 does not represent a policy violation, it may signal watcher module 402, to allow the output data of low-code module 302 to be passed as input to low-code module 304. However, if compliance engine 404 determines that a policy violation exists, it may instead signal watcher module 402 to block that output data from being used by 304. In another embodiment, 404 may also generate and send an alert, such as by notifying the user modifying the low-code workflow, an administrator, or other interested user.

In some embodiments, watcher module 402 may be transparent from the perspective of a low-code programmer. In other words, while low-code module 302 and low-code module 304 may be presented on screen to the programmer, the insertion of watcher module 402 between these modules may not be presented in the graphical user interface (GUI) of the programming environment. In other cases, of course, the insertion of watcher module 402 between low-code module 302 and low-code module 304 may also be represented on screen.

Compliance engine 404 may determine whether the use of the output data of low-code module 302 by low-code module 304 constitutes a policy violation in variety of ways, according to various embodiments. For instance, compliance engine 404 may determine that the output data constitutes a policy violation if any of the following conditions exist:
The output data from low-code module 302 includes protected information that the owner of the low-code workflow is not authorized to use in the workflow. For instance, a policy violation may exist if low-code module 302 includes confidential or proprietary information, trade secret information, personally identifiable information (PII), or any other information that has been identified as being protected.
The action to be performed by low-code module 304 using the output data from low-code module 302, or performed by another downstream module of the low-code workflow. Indeed, even if the data output by low-code module 302 itself does not constitute a policy violation, the action performed on that data by the workflow may itself be a violation.
The use of the output data is contrary to an overall intent of the low-code workflow. Here, even if a specific action performed by one of the component modules of the low-code workflow using the output data of low-code module 302 is allowed, it may nonetheless violate the overall intent of the workflow.
Configuration of the low-code workflow to use the output data from low-code module 302 as input to low-code module 304 represents a behavioral anomaly on the part of the programmer.

In various embodiments, the above analysis by watcher module 402 and compliance engine 404 may determine whether a policy violation exists in part based on a transaction profile associated with the executor or author of the low-code workflow, or to the workflow itself. In general, such a transaction profile may include information about not only the data passed between two low-code modules, but also how that data is used throughout the application. Indeed, by examining modules that are later in the chain of events of the workflow, compliance engine 404 can establish some contextual intent of how data is being manipulated and delivered to each independent module in the workflow. This information equates to learning the normal operating procedures of the user, and/or the workflow, and establishes a baseline of the types of data and output methods that are commonly used in their workflows.

As would be appreciated, relying on a transaction profile provides a more robust security framework outside of rule-based matching or individual module fuzzing by evaluating intent throughout the low-code workflow. In turn, compliance engine 404 can incorporate its learned transaction profile, for purposes of policy enforcement. More specifically, compliance engine 404 may construct a transaction profile by inserting watcher modules between any or all of the modules of the workflow(s) created by a certain user, allowing compliance engine 404 to obtain information about the types of data used by the workflow. In turn, compliance engine 404 may generate one or more transaction profiles for the workflow and/or its author, potentially also based on information learned from other workflows. In some instances, compliance engine 404 may apply machine learning to this problem, to establish a baseline profile against which further workflow edits may be compared.

In other words, compliance engine 404 may implement locally-defined policies to ensure that the execution of a module that may look harmless on its own is not of a larger problem to exfiltrate or mishandle data. Reporting in real-time of data or behavioral violations can decrease the response time needed for investigating data breaches or exfiltration. This ongoing behavioral analysis by compliance engine 404 provides the users the guard rails needed to keep data safe, while still extending developer tooling to users that may not have programming knowledge.

Inclusion of the user and their behavior into the policy enforcement allows enterprises to address the biggest challenge with empowering everyone to create and innovate. Accordingly, watcher module 402 and compliance engine 404 enable visibility and control without compromising the ease of low-code development, while also allowing for the least privileged access and micro-segmentation policies to consistently be injected into the low-code flow process. As a result, a zero trust mechanism is implemented throughout the low-code system. Because this approach decouples the low-code widget block from the policy and enforcement compliance engine, the techniques herein are able to work across low-code platforms and provide a central compliance engine across systems. In addition, the techniques herein can offer more capabilities with integrating each low-code block with other corporate compliance and security systems, to enforce the user behavioral profile beyond what the closed system can offer. The openness of the watcher module approach also allows enterprises to leverage their existing investment of best of breed security and compliance tools through a central policy engine for low code. With the intelligence in the central compliance engine versus in the low code platform itself, the watcher module can also adapt to the policies defined by the organization.

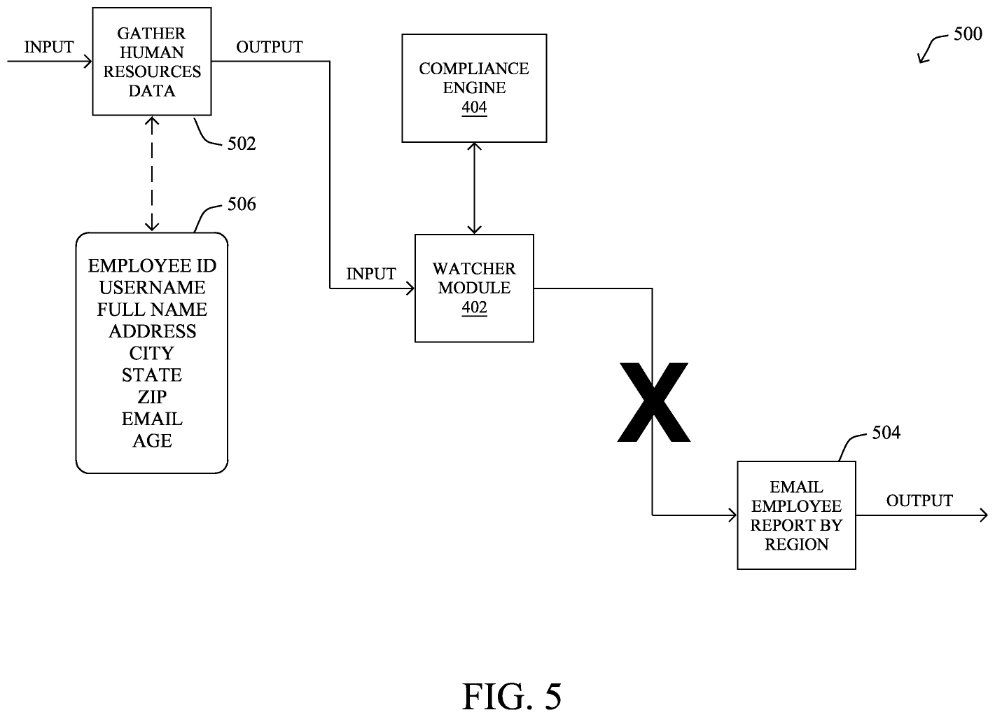

By way of example, FIG. 5 illustrates an example 500 of a watcher module blocking use of data in a low-code workflow. As shown, assume that the system inserts watcher module 402 between low-code module 502, which is configured to gather human resources data, and low-code module 504, which is configured to email an employee report by region.

During execution, low-code module 502 may retrieve various human resources (HR) data 506, such as employee ID information, username information, the full names of employees, employee address information, employee location information (e.g., their city, state, zip code, etc.), employee email addresses, and/or employee ages. Hence, HR data 506 may comprise PII data that may be deemed by policy as restricted or sensitive information. Once retrieved, low-code module 502 may then output HR data 506 for input to low-code module 504.

Before HR data 506 is passed to low-code module 504, watcher module 402 may intercept HR data 506 and send it to compliance engine 404 for analysis. Here, compliance engine 404 may look to various policy factors, to determine whether the use of HR data 506 in the workflow constitutes a policy violation. For instance, compliance engine 404 may determine that a policy violation exists if any of the following policy rules exist:
The workflow owner or programmer is unauthorized to use or access HR data 506 at all.
An action performed using HR data 506 by low-code module 504, or any subsequent modules in the workflow, is unauthorized. For instance, the workflow owner or programmer may be allowed to use HR data 506, but not in conjunction with low-code module 504, which may email an employee report to external email addresses.
The overall intent of the workflow does not match the data (or actions performed thereto). For instance, if the overall workflow relates to generating part number reports, but also includes a portion devoted to emailing out HR data 506, this may be deemed as a policy violation.
The behavior of the programmer is abnormal. For instance, if the programmer suddenly goes from creating workflows reporting part numbers to reporting employee information, this may constitute a policy violation.

If compliance engine 404 determines that any of the above policy violations exist, compliance engine 404 may signal to watcher module 402 to block the sending of HR data 506 to low-code module 504. In addition, compliance engine 404 may raise an alert regarding the output data, to notify the programmer, their supervisor, and/or another interested party as to the policy violation.

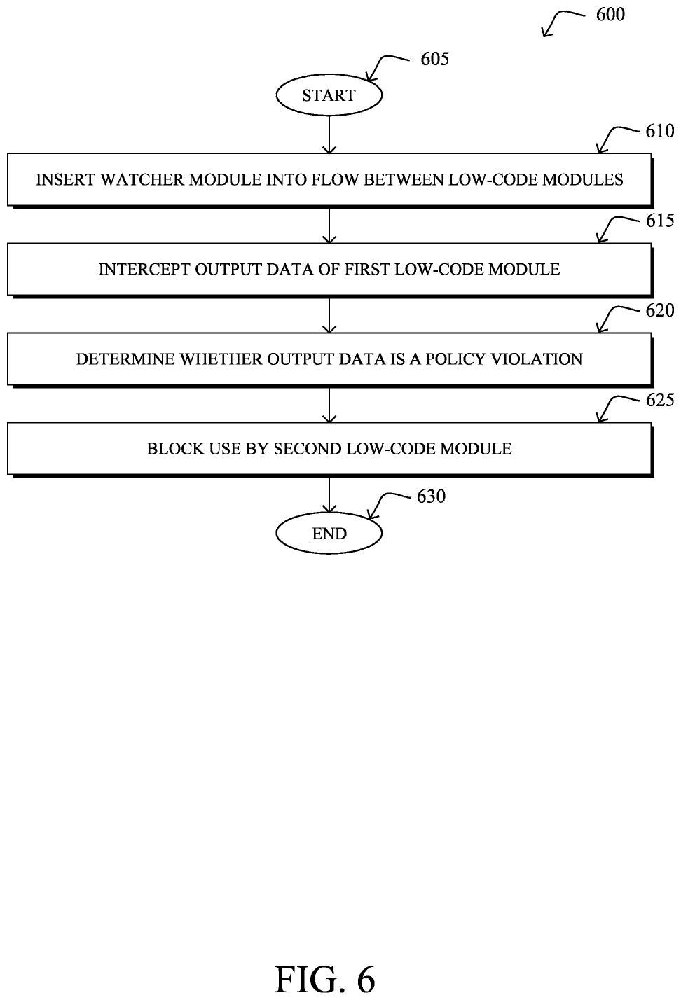

FIG. 6 illustrates an example simplified procedure for evaluating data passed in a low-code workflow, in accordance with one or more embodiments described herein. For example, a non-generic, specifically configured device (e.g., device 200) may perform procedure 600 by executing stored instructions (e.g., policy enforcement process 248). The procedure 600 may start at step 605, and continues to step 610, where, as described in greater detail above, the device may insert a watcher module between a first module and a second module in a low-code workflow. In some embodiments, the device may first generate the watcher module, based in part on the first module and the second module, such as by adapting a template watcher module to the specific output data of the first module that is intended to be used as input to the second module.

At step 615, as detailed above, the device may intercept, via the watcher module, output data being passed by the first module to the second module. More specifically, the watcher module may take as input the output data from the first module, prior to it being used as input to the second module. This allows the watcher module to capture the output data for purposes of analysis and policy enforcement.

At step 620, the device may determine whether the output data represents a policy violation, as described in greater detail above. In some embodiments, the device may do so by determining whether the output data includes sensitive information restricted from being shared, such as confidential or proprietary information, trade secret information, personally identifiable information (PII), or any other information that may be restricted from being used in a certain way. In further embodiments, the device may make this determination in part by determining whether an action performed by the second module, or by any subsequent modules to it in the low-code workflow (e.g., a third module, a fourth module, etc.), would represent a policy violation if performed using the output data. For instance, while the use of certain PII information may be allowed, sharing that information with an external email address may constitute a policy violation. In another embodiment, the device may make this determination based in part on a determination as to whether an owner of the low-code workflow s authorized to use the output data. In yet another embodiment, the device may also make this determination in part by determining an intent of the low-code workflow and comparing the output data to that intent (e.g., to a transaction profile for the workflow). For instance, if the overall intent of the workflow is to generate a report on certain types of data, inclusion of data outside of this intended use may constitute a policy violation. In a further embodiment, the device may make the determination based in part by using a behavioral profile for a developer of the first module to determine that the output data of the first module is anomalous (e.g., if the output data is not of a type that the developer typically uses).

At step 625, as detailed above, the device may block use of the output data by the second low-code module, when the output data represents a policy violation. For instance, the device may prevent the watcher module from passing the output data from the first module to the second module. Conversely, if the output data does not represent a policy violation, the device may pass, via the watcher module, the output data from the first module to the second module as input, when the output data does not represent a policy violation. Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques herein, therefore, introduce a policy enforcement mechanism to low-code development tools. In some aspects, the techniques herein allow for the transparent interception and evaluation of data between low code modules against corporate policy enforcement and data protection rules. In further aspects, the techniques herein also provide ability to “look ahead” at other modules in a low code chain of events and determine an action based on security and compliance rules. In additional aspects, the techniques herein also allow for the ability to project intended use of data by evaluating the next set of input and output methods in a low-code workflow. In another aspect, the techniques herein provide the ability to “break out” of a low-code module chain as a result of a violation of external policy enforcement actions. In yet another aspect, the techniques herein provide the ability for user behavior to integrate into open policy systems for behavioral compliance and validation. In a further aspect, the techniques herein allow for the use of historical behavior to determine the intent of an application or workflow consisting of multiple low code modules. In another aspect, the techniques herein allow for the identification of deviation of normal or expected user behavior in workflows consisting of multiple low code modules.

While there have been shown and described illustrative embodiments that provide for policy enforcement in low-code environments, it is to be understood that various other adaptations and modifications may be made within the spirit and scope of the embodiments herein. For example, while certain embodiments are described herein primarily with respect to a visual programming environment, the techniques can be extended without undue experimentation to other programming or configuration environments, as well.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
inserting, by a device, a watcher module between a first module and a second module in a low-code workflow;
intercepting, by the device and via the watcher module, output data being passed by the first module to the second module;
determining, by the device, whether the output data represents a policy violation; and
blocking, by the device and via the watcher module, the output data from being input to the second module, when the output data represents a policy violation.

2. The method as in claim 1, further comprising:
generating, by the device, an alert regarding the output data, when the output data represents a policy violation.

3. The method as in claim 1, wherein determining whether the output data represents a policy violation comprises:
determining whether the output data includes sensitive information restricted from being shared.

4. The method as in claim 1, further comprising:
generating the watcher module, based in part on the first module and the second module of the low-code workflow.

5. The method as in claim 1, wherein determining whether the output data represents a policy violation comprises:
determining whether an action, performed by the second module, or by any subsequent modules to it in the low-code workflow, would represent a policy violation if performed using the output data.

6. The method as in claim 1, wherein determining whether the output data represents a policy violation comprises:
determining whether an owner of the low-code workflow is authorized to use the output data.

7. The method as in claim 1, wherein determining whether the output data represents a policy violation comprises:
using a behavioral profile for a developer of the first module to determine that the output data of the first module is anomalous.

8. The method as in claim 1, further comprising:
determining an intent of the low-code workflow, wherein the device determines whether the output data represents a policy violation based on the intent of the low-code workflow.

9. The method as in claim 8, wherein the device determines the intent of the low-code workflow by comparing the low-code workflow to a transaction profile.

10. The method as in claim 1, further comprising:
passing, via the watcher module, the output data from the first module to the second module as input, when the output data does not represent a policy violation.

11. An apparatus, comprising:
a network interface to communicate with a computer network;
a processor coupled to the network interface and configured to execute one or more processes; and
a memory configured to store a process that is executed by the processor, the process when executed configured to:
insert a watcher module between a first module and a second module in a low-code workflow;
intercept, via the watcher module, output data being passed by the first module to the second module;
determine whether the output data represents a policy violation; and
block, via the watcher module, the output data from being input to the second module, when the output data represents a policy violation.

12. The apparatus as in claim 11, wherein the process when executed is further configured to:
generate an alert regarding the output data, when the output data represents a policy violation.

13. The apparatus as in claim 11, wherein the apparatus determines whether the output data represents a policy violation by:
determining whether the output data includes sensitive information restricted from being shared.

14. The apparatus as in claim 11, wherein the process when executed is further configured to:
generate the watcher module, based in part on the first module and the second module of the low-code workflow.

15. The apparatus as in claim 11, wherein the apparatus determines whether the output data represents a policy violation by:
determining whether an action, performed by the second module, or by any subsequent modules to it in the low-code workflow, would represent a policy violation if performed using the output data.

16. The apparatus as in claim 11, wherein the apparatus determines whether the output data represents a policy violation by:
determining whether an owner of the low-code workflow is authorized to use the output data.

17. The apparatus as in claim 11, wherein the apparatus determines whether the output data represents a policy violation by:
using a behavioral profile for a developer of the first module to determine that the output data of the first module is anomalous.

18. The apparatus as in claim 11, wherein the process when executed is further configured to:
determine an intent of the low-code workflow, wherein the apparatus determines whether the output data represents a policy violation based on the intent of the low-code workflow.

19. The apparatus as in claim 18, wherein the apparatus determines the intent of the low-code workflow by comparing the low-code workflow to a transaction profile.

20. A tangible, non-transitory, computer-readable medium storing program instructions that cause a device to execute a process comprising:
inserting, by the device, a watcher module between a first module and a second module in a low-code workflow;
intercepting, by the device and via the watcher module, output data being passed by the first module to the second module;
determining, by the device, whether the output data represents a policy violation; and
blocking, by the device and via the watcher module, the output data from being input to the second module, when the output data represents a policy violation.
